(19) United States
(12) Patent Application Publication
(10) Pub. No.: US 2010/0050809 A1
(43) Pub. Date: Mar. 4, 2010

(54) FORCES GENERATIVE METHOD

(76) Inventor: Bojidar Djordjev, Varna Region (BG)

Correspondence Address: Aleksandr Smushkovich, POB 140505, Brooklyn, NY, 11214, US

(21) Appl. No.: 12/312,734

(22) PCT Filed: Sep. 25, 2007
(86) PCT No.: PCT/BG2007/000022

§ 371 Date: May 22, 2009

(30) Foreign Application Priority Data
Dec. 12, 2006 (BG) 109772

(51) Int. Cl. F03G 3/08

(52) U.S. Cl. 74/572.1

(57) ABSTRACT

A forces generative method is disclosed that generally comprises providing minimum one rotatable flywheel, providing the flywheel's first movement as rotation having a frequency f1, providing the flywheel's second cyclic movement simultaneously and phase-synchronized with the first movement, in the forms of rotation, swinging, linear reciprocating, and any combination thereof. The flywheel comprises a plurality of N=2, 3, 4, etc. work branches having equal or different masses concentrated along N radial directions and having an angle between any two adjacent N radial directions equal to 360 degrees divided by N, a plurality of connecting elements joining the work branches and having masses distributed along radial directions distinct from the N directions. The second movement has a frequency f2 equal to f1 multiplied by N multiplied by an aliquot coefficient K=1, 2, 3, etc. It's usable in propulsion systems, for attitude/orbit control, spacecraft artificial gravitation, in drills, screwdrivers, etc.

### REFERENCES TO RELATED APPLICATIONS

This patent application is a US National Phase of PCT/BG2007/000022 filed 25 Sep. 2007 that claims priority of a Bulgarian patent application BG109772 filed 12 Dec. 2006, hereby entirely incorporated by reference.

### FIELD OF THE INVENTION

The invention discloses a Forces Generative Method related to a closed system of solid objects generating forces at the expense of potential energy stored in the system. More particularly, the invention concerns a Gyro based propulsion method, which can be used to propel vehicles into linear, rotary, swinging, and other types of motion.

### GENERAL DISCUSSION OF BACKGROUND OF THE INVENTION

In mechanics, there are known the first, the second and the third Newton's laws that state: 1) Every object remains its state of motion unless the external force is applied to it. 2) The force applied on an object is equal to its mass multiplied by its acceleration. 3) The object reacts with another force equal to the applied one but opposite to it.

There are also known the law of Conservation of Momentum and the law of Conservation of Angular Momentum that state: a) The total momentum of a closed system of objects is constant. b) The total angular momentum of a closed system of objects is constant.

The main conclusion one can make here is that in fact the above mentioned laws present a linear or 1D concept, because the vectors of velocity, acceleration, force and momentum of the interacting bodies, in case of the linear motion, and the vectors of angular velocity, angular acceleration, torque and angular momentum, in case of the rotation motion, act in line (i.e. parallel and in the opposite directions).

A disadvantage of the forces generative methods based on the above mentioned laws is that: to propel a vehicle there is a need of caring on board of the vehicle a propellant and throwing it backward in relation to the intended movement.

There is known the Gyroscopic effect in which: if a flywheel rotates about its axis (a first axis) of rotation and simultaneously is turned about a second axis perpendicular to the first one, a precession torque is generated about a third axis perpendicular to both the first and the second ones. If the turning is continued, the generated precession torque about fixed axis decreases to zero. If the turning is continued beyond that point or backward, the generated precession torque is recovered, but it acts in the opposite direction. This Gyro's behavior is usually used to prove the Law of Conservation of Angular Momentum.

The Gyroscope is the only known device that is able to perform the aforementioned 3D behavior. On the other hand, three permanent torques, acting about fixed mutually perpendicular axes, cannot be generated with this “original” Gyroscope. If one can somehow make these three mutually perpendicular torques to act unidirectionaly and permanently about the fixed axes, the 3D behavior will be achieved. The inventive 3D concept is quite different from the above mentioned linear one and this is the problem to be solved by this invention.

An example of a forces generative method, based on the Gyro effect, is shown in GB Pat. 2215048 “Linear force from rotating system” issued in 1989. The method comprises three simultaneous movements of at least one flywheel: a first movement is a rotation about the flywheel's centre; a second movement is a rotation with a constant speed about a point aligned with but spaced from flywheel's centre; a third movement is a cyclic movement done so that a flywheel controlled by a cam, moves slowly upward in a direction parallel to the axis of precession due to its own naturally tendency to precess and then is forced by the cam downwardly.

The next example is WO1991/002155 (U.S. Pat. No. 5,090,260 issued in 1992) “Gyrostat propulsion system”, which method also comprises three simultaneous movements of a gyrostat wheels: a first movement is a rotation about the wheels' axes of rotation; a second movement is a rotation about side principal axes; a third movement is a connected to the second movement rotation about principal axis central for the device.

Another example is U.S. Pat. No. 5,024,112 “Gyroscopic apparatus”, issued in 1991, representing a method that comprises three simultaneous movements of a pair of discs: a first movement is a spin in opposite directions about the discs' axes; a second movement is a rotation of the whole assembly about a second axis central for the assembly; a third movement is a periodically forcing the discs towards one another allowing them to return; wherein the second axis is perpendicular to the axis of the third movement.

Analyzing the mentioned prior art methods, one can say that: first—all of them, like the “original” Gyro, use rotary single body balanced flywheels having masses equally distributed along their radial directions, regardless to how they are shaped, e.g. disks, rotors, and rings, supported by spokes or other similar means; second—the first movement is always a flywheel's rotation about its axis, extending through the flywheel's centre; and third—the simultaneous second movement, being in the “original” Gyro a one way turning, replaced here with a rotation about a point or another axis aligned with but spaced from the flywheel's centre.

The drawbacks of these methods come from the misunderstanding that the precession is a result of a number of generated pairs of forces acting around the flywheel's center from every possible diametrical directions, so that a single pair can be decomposed and a single force can be extracted. That's why, it is explicably why the above mentioned class of flywheels is used, and that their using does not require the cyclic second movement to be specified as consisting of strokes, its frequency in relation to the frequency of the first movement to be defined, and also synchronization between the first and the second movements to be established.

It is known that rotation is a special case of cyclic movement, for example, similar to the swinging movement, linear reciprocating, oscillation, movement following a closed trajectory described by a given path, or others. The important positive steps one can take from these prior art methods are that the rotation, being a special case of cyclic movement, is introduced as the second movement, and that the flywheel's centre is distanced from the axis of the second movement. A disadvantage of those methods however is their low efficiency.

### SUMMARY OF THE INVENTION

A primary purpose of the invention is to provide an effective Forces Generative Method, based on the Gyro effect, which method should create high-frequency consecutive perpendicular to each other toques, or torques and forces that allow the non-reactive torques or forces to be separated by means of co-operating inventive devices. These forces can be considered as permanent forces acting from a flywheel (or a number of flywheels) upon a vehicle carrying the flywheel, wherein the flywheel and vehicle can be considered a closed system. In this way, these forces are capable of rotating and/or moving the flywheel and vehicle throughout space. Other purposes can be appreciated by those skilled in the art upon learning the present disclosure.

The invention is premised on a notion that the generated precession torque is a result of a number of generated pairs of forces acting around the flywheel's center from each diametrical direction. The invention is also founded on the supposition that for a certain moment of time during the flywheel's rotation about its axis of rotation and its simultaneous turning or rotation about a second axis, there is a pair of forces that appears with a maximal magnitude on the radial directions of the flywheel that pass through certain orientations. Vice-versa, there is another pair of forces that appears with a minimal magnitude on other radial directions passing through a line perpendicular to the certain orientations.

Therefore one can suppose that each pair of the forces acting upon two elementary pieces of mass along one diametrical direction of the flywheel's periphery periodically changes its magnitude from zero to a maximum and from the maximum to zero. Then one can suppose that each force from the pair periodically changes its direction as well. This periodicity or regularity delivers an opportunity for creating high-frequency consecutive momentums of single pair forces by introducing a cyclic second movement synchronized with the flywheel's rotation about its axis of rotation. This would create two-stroke cyclic movements that can be arranged by means of a flywheel having a mass concentrated along predetermined radial directions.

According to the invention, its preferred embodiments encompass the use of at least one balanced flywheel comprising a plurality of N (wherein N=2, 3, . . . ) ‘work branches’ representing separated sectors of the flywheel (e.g. a disk-shaped flywheel), having equal or different masses, concentrated along N radial directions extending through the center of flywheel, and an angle between any two adjacent radial directions is equal to 360 degrees divided by N, wherein the work branches' masses are joined by connecting elements, and the connecting elements possess masses distributed along radial directions extended through the other sectors of the flywheel, excluding the work branches, or simply the directions distinct from the N radial directions of the branches.

During a first stroke, herein called a “work stroke”, the work branches passing through the maximum magnitude orientations generate maximal magnitude momentums of forces acting in directions, herein identified as “forward” ones. A second stroke is intended to conserve the Gyro's 3D frame of reference by recovering the work stroke starting position. During this “recovering stroke”, the work branches passing through the minimum magnitude orientations generate minimal momentums of forces in directions, herein identified as “opposite” ones. During the cycle, the flywheel acts upon the vehicle with the generated maximal magnitude momentums of forces having the “forward” directions, but reduced with the minimal magnitude “opposite” ones, and also with forces and torques reactive to the flywheel's rotation and the cyclic second movement. Created by the high-frequency consecutive cycles, all these forces and torques can be considered as permanently acting ones.

The cyclic second movement can be represented in the form of: rotation, swinging movement, linear reciprocating, and a combination of them. In case of rotation, the first and the second strokes of the cycle are the first and the second semicircles of the described circle, defined along a chosen “forward” direction. In case of swinging or linear reciprocating movements the first and the second strokes of the cycle are the first and the second semi-periods of the swinging or reciprocating movements, and are also defined along a chosen “forward” direction.

In particular, the method supposes collective operating of two or more flywheels generating same-named torques and forces acting about the same-named axis in the way that the same-named torques and forces have the same magnitudes, and therefore the flywheels can be called “sister”.

Detailed explanation of this property of the 3D concept is another deep subject matter that can be illustrated by a simple example involving two sister flywheels generating torques only. There is possibility to place the flywheels in space and connect them together with the vehicle in a closed system in the way that their same-named axes would be parallel each other, and their two pairs of the same-name toques would act toward opposite to each other directions, but at the same time, the third pair of the same-named torques would act in the same direction. In this way, the torques from the first two pairs would balance each other and thus the same-named torques from the third pair are isolated or separated by the others. Therefore the isolated pair, acting in one direction, and in parallel torques, is a torque, acting on the vehicle, and having a magnitude equal to the sum of the magnitudes of the isolated (separated) torques. In general, using two or more collectively operated sister flywheels, the above mentioned principle allows separating or isolating some of the same-named torques and forces, generated during the cycles, by counter-balancing the remaining same-named torques and forcers.

The method's advantage is that it efficiently generates prerequisite permanent unidirectional propulsion torques and/or forces, as described above.

Therefore, the inventive forces generative method in general comprises the steps of:
providing at least one solid single body flywheel having a center, mounted for a first rotation about a first axis extending through the center, the flywheel is driven by a drive means (generally including a conventional motor and transmission mechanisms if necessary);
providing a first movement of the flywheel in the form of the first rotation having a frequency f1;
providing a second cyclic movement of the flywheel simultaneously and phase-synchronized with the first movement, the second movement is provided in any form selected from the group consisting of: rotation, swinging, linear reciprocating, and any combination thereof; wherein the flywheel comprises:
a plurality of N work branches, wherein N can have any value from the following sequence: 2, 3, 4, etc.; the work branches have equal or different masses, concentrated along any N radial directions extended from the center, and an angle between any two adjacent of the N radial directions is equal to 360 degrees divided by N;
a plurality of connecting elements joining the work branches and having masses distributed along predetermined radial directions distinct from the N radial directions;
and wherein the second movement having a frequency f2 equal to f1 multiplied by N multiplied by a predetermined aliquot coefficient K, wherein K can have any value from the following sequence: 1, 2, 3, etc.

### BRIEF DESCRIPTION OF THE DRAWINGS

FIG. 1 is an exemplary shape of a solid flywheel (1), comprising two work branches (2) having substantially equal masses concentrated along radial directions “R”, and two connecting elements (3), joining the branches (2), and having masses distributed along other radial directions distinct from the directions “R”.

FIG. 2 is an exemplary shape of a flywheel 1, comprising two work branches (21) and (22) having different masses concentrated along radial directions “R”, and two connecting elements 3, joining the work branches 21 and 22, and having masses distributed along other radial directions distinct from the directions “R”.

FIG. 3 is an exemplary shape of a flywheel 1 comprising three work branches (2) having substantially equal masses concentrated along radial directions “R”, and six connecting elements (3), joining the work branches 2, and having masses distributed along other radial directions distinct from the directions “R”.

FIG. 4 is an exemplary scheme of a forces generative method based on one flywheel 1, which encompasses a first movement and a second movement represented as a swinging movement about an axis O2-O2 perpendicular to the axis of first movement O1-O1.

FIG. 5 is an exemplary scheme of a forces generative method based on one flywheel 1, which encompasses a first movement and a second movement represented as a linear reciprocating about an axis O2-O2 perpendicular to the axis of first movement O1-O1.

FIG. 6 is an exemplary scheme of a forces generative method based on two flywheels 1, which encompasses a first movement and a second movement represented as a rotary movement about axis O2-O2 perpendicular to the axis of the first movement O1-O1.

Identical reference numerals or letters in the drawings generally refer to the same elements in different figures. A first-time introduced numeral or letter in the description is enclosed into parentheses.

### DESCRIPTION AND OPERATION OF THE INVENTIVE PREFERRED EMBODIMENTS

While the invention may be susceptible to embodiment in different forms, there are shown in the drawing, and will be described in detail herein, specific embodiments of the present invention, with the understanding that the present disclosure is to be considered an exemplification of the principles of the invention, and is not intended to limit the invention to that as illustrated and described herein.

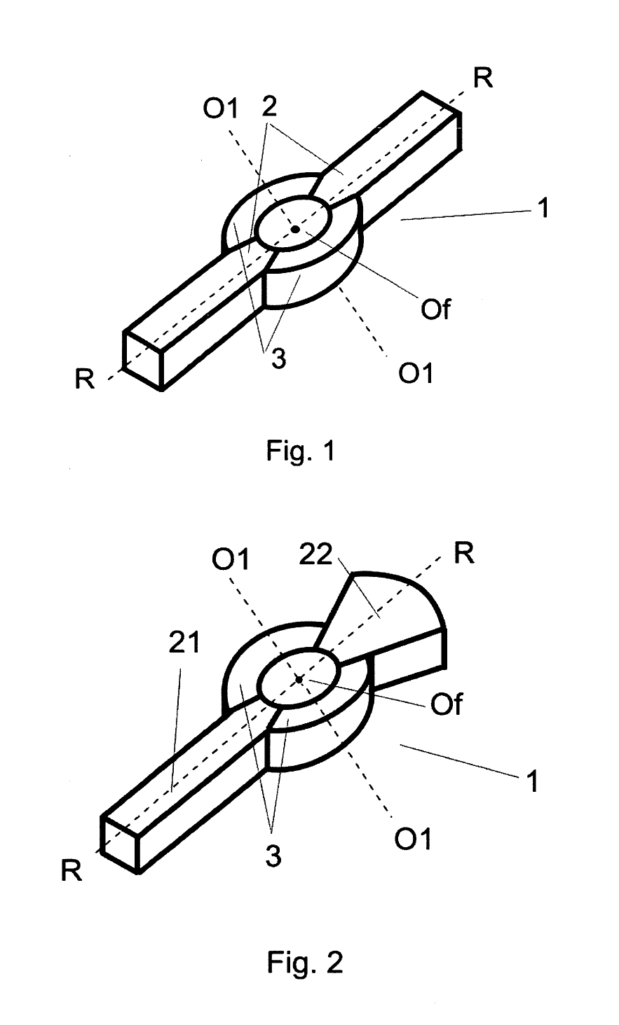

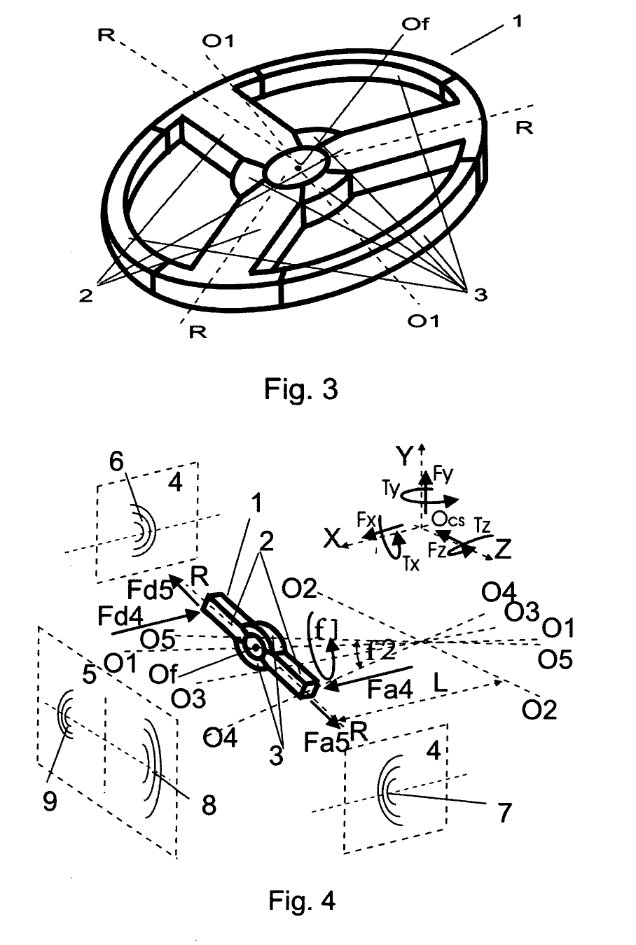

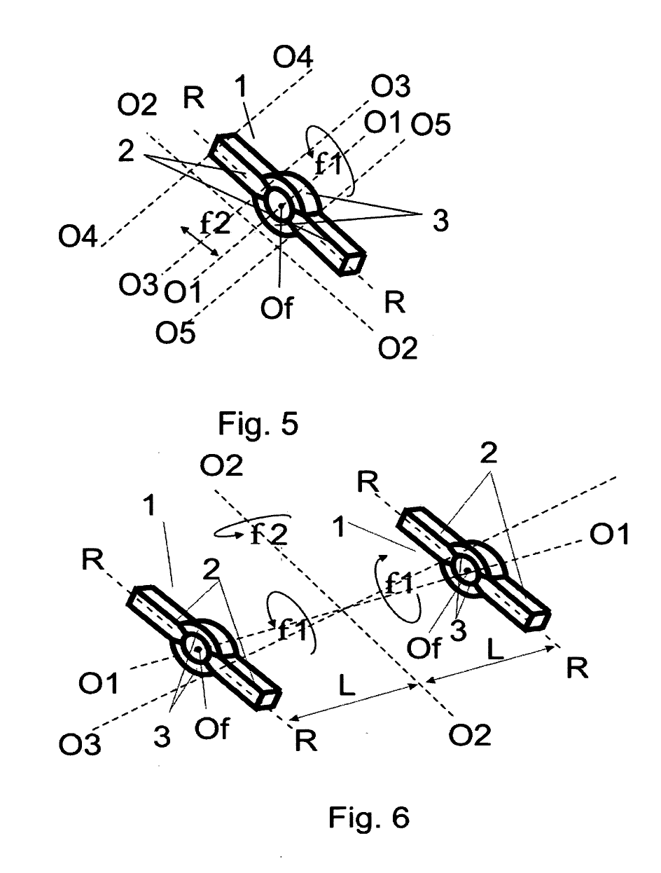

FIG. 4 illustrates the inventive Forces Generative Method that uses a flywheel 1 depicted on FIG. 1. The flywheel 1 is made as a solid single body object of a suitable material (or alternatively can be made of a necessary number of different materials), having a center “Of”, and comprising: two work branches 2, having equal masses concentrated along radial directions “R”. The flywheel is balanced about its axis of rotation O1-O1. The center “Of” is spaced with a distance “L” from the axis of second movement O2-O2. The branches 2 are joined by connecting elements (3) having masses distributed along other radial directions distinct from the directions “R”.

The flywheel 1 is revolvably mounted for rotation about an axis of rotation O1-O1, and for a swinging movement between the ends of deviation lines O4-O4 and O5-O5, wherein the swinging movement is provided about an axis O2-O2 perpendicular to the axis O1-O1, and spaced with a distance “L” from the flywheel's centre “Of”. The flywheel 1 is mounted by means of conventional machine parts and driven by conventional motors (not shown) associated with known drives (not shown) having synchronization capabilities.

The flywheel 1 carries out two simultaneous phase-synchronized movements: a rotation about its axis O1-O1 with a frequency f1, and a swinging movement about the axis O2-O2 with a frequency f2 equal to the frequency f1 multiplied by the number of the flywheel's work branches 2. In general: f2=K×N×f1; where K=1, 2, . . . (K is an aliquot coefficient); and N=2, 3, . . . (N is the number of work branches).

In some embodiments, the synchronization is arranged in the way that, during the work stroke, the radial directions “R” pass through certain orientations parallel to the axis O2-O2 when the axis O1-O1 passes through a work stroke mid position line O3-O3. During this stroke, every elementary piece of the masses of the work branches 2 participate in 3D trajectories, which projections on planes (4) parallel to the swinging movement plane (not shown), and on a plane (5) perpendicular to the work stroke mid position line O3-O3, are families of arcs (6), (7), (8) and (9). The two arc families 6 and 7, shown on the planes 4, are bulged opposite, as well as the two arc families 8 and 9 shown on the plane 5.

Following these trajectories, each elementary mass creates a centrifugal force. Summing them separately for each work branch 2 and for each plane 4 and 5 in the frame of the stroke, one obtains summary centrifugal forces Fa4, Fd4, Fa5, and Fd5.

If the distance “L” is close to zero (i.e. substantially small), Fa5=Fd5 and act opposite along one line, these forces do not create a net force and do not create a net torque. Similarly, Fa4=Fd4 and act opposite along parallel lines, hence they also do not create a net force. But acting distanced and in parallel, Fa4 and Fd4 do create a net torque (not shown) around the flywheel's centre “Of” that is in fact causing a precession torque. Though the centrifugal forces are commonly considered to be fictive forces, it should be noted here that these are the forces producing the precession torque.

However, as the distance “L” is greater than zero, one of the work branches 2, receiving an additional periphery speed from the swing (not shown), a so called “attacking” branch, moves longer and along the less bulged arcs 7 and 8, generating summary forces Fa4 and Fa5 greater than before.

Unlike the attacking branch, the other work branch, having a reduced by the swing periphery speed (a so called “defending” branch, not shown), moves shorter and along more bulged arcs 6 and 9 generating summary forces Fd4 and Fd5, smaller than before. Thusly, Fa4>Fd4, which creates a net torque and a net force (not shown); and, since Fa5>Fd5, this creates a net force (not shown) acting around the flywheel's centre “Of”.

The picture becomes more complicated if one includes forces generated during the recovering stroke, and also forces reactive to the flywheel's rotation and the swinging movement (all not shown). Finally, because of their high frequencies, this bunch of changeful forces can be represented in the frame of the cycle with three forces: Fx, Fy, and Fz and three torques: Tx, Ty, and Tz, acting permanently about the axis “X”, “Y” and “Z” passing through the mass centre “Ocs” of the closed system, composed of the flywheel 1 and a vehicle (not shown) carrying the flywheel. (See the picture in the upper right corner of FIG. 4)

The so described 3D concept provides new opportunities: some of the torques or/and forces acting about the closed system's mass centre “Ocs” can be separated from the rest of the ones by their balancing with sister torques or/and forces generated by a combined work of sister flywheels.

The invention has been successfully embodied, and can be used as a main propulsion system, to provide attitude or orbit control and artificial gravitation for spacecrafts, satellites and other vehicles, and also in drills, screwdrivers, and other machines.

1-8. (canceled)

9. A forces generative method comprising the steps of:
providing at least one solid single body flywheel having a center, mounted for a first rotation about a first axis extending through said center, said flywheel driven by a drive means;
providing a first movement of said flywheel in the form of said first rotation having a frequency f1;
providing a second cyclic movement of said flywheel simultaneously and phase-synchronized with said first movement, said second movement is provided in any form selected from the group consisting of: rotation, swinging, linear reciprocating, and any combination thereof;
wherein said flywheel comprising:
a plurality of N work branches, wherein N can have any value from the following sequence: 2, 3, 4, etc.; said branches having equal or different masses, concentrated along any N radial directions extended from said center, and an angle between any two adjacent said N radial directions is equal to 360 degrees divided by N;
a plurality of connecting elements joining said work branches and having masses distributed along predetermined radial directions distinct from said N radial directions;
and wherein
said second movement having a frequency f2 equal to f1 multiplied by N multiplied by a predetermined aliquot coefficient K, wherein K can have any value from the following sequence: 1, 2, 3, etc.

10. The method according to claim 9, wherein said flywheel is made of a number of materials, wherein the number of materials can have any value from the following sequence: 1, 2, 3, etc.

11. The method according to claim 9, wherein said second movement is a rotation including two strokes with trajectories shaped as semicircles.

12. The method according to claim 9, wherein said second movement is a swinging including two semi-period strokes.

13. The method according to claim 9, wherein said second movement is a second rotation or swinging, and said flywheel is mounted for the second rotation or swinging about a second axis disposed parallel to said first axis.

14. The method according to claim 9, wherein said second movement is a second rotation or swinging, and said flywheel is mounted for the second rotation or swinging about a second axis disposed perpendicular to said first axis.

15. The method according to claim 9, wherein said second movement is a linear reciprocating, and said flywheel is mounted for the linear reciprocating along a second axis disposed parallel to said first axis, and said linear reciprocating includes two semi-period strokes.

16. The method according to claim 9, wherein
said second movement includes two semi-period strokes, one of said strokes is a work stroke having a mid-position line;
said flywheel is mounted to provide said second movement about or along a second axis; and
the phase-synchronization is arranged in the following way: at least one of said N radial directions passes through an orientation parallel to said second axis, when said first axis passes through the mid-position line.

17. The method according to claim 9, wherein
said second movement is provided in the form of rotation or swinging, said second movement includes two semi-period strokes, one of said strokes is a work stroke having a mid-position line;
said flywheel is mounted to provide said second movement about a second axis; and
the phase-synchronization is arranged in the following way: at least one of said N radial directions passes through an orientation perpendicular to said second axis, when said first axis passes through the mid-position line.
